(19) United States
(12) Patent Application Publication
(10) Pub. No.: US 2005/0152767 A1
(43) Pub. Date: Jul. 14, 2005

(54) Wall plug

(76) Inventors: Simon James Skillings, Burton-on Trent (GB); Paul Steabben Hepworth, Guildford (GB)

Correspondence Address: NIKOLAI & MERSEREAU, P.A., 900 SECOND AVENUE SOUTH, SUITE 820, MINNEAPOLIS, MN, 55402, US

(21) Appl. No.: 11/010,737

(22) Filed: Dec. 13, 2004

(30) Foreign Application Priority Data
Jun. 11, 2003 (WO) PCT/GB03/02526
Jun. 14, 2002 (GB) 0213702.4

(51) Int. Cl. F16B 1/00

(52) U.S. Cl. 411/80.1

(57) ABSTRACT

A wall plug for insertion into a hole or bore in a wall comprising a elongate body having an internal bore, the bore having an opening at the first end of the body, and rotation means located at the first end of the body, the rotation means being operable to permit the elongate body to be rotated when located in said wall hole or bore, the opening being offset from, and the bore being inclined relative to, the longitudinal axis of the body.

The invention relates to a wall plug for insertion into a hole or recess formed in a solid wall.

Wall plugs are commonly inserted into holes drilled in masonry prior to inserting screws into the holes. On insertion of a screw into a wall plug received in a hole, the wall plug expands and engages the internal surface of the hole. Frictional engagement between the wall plug and the internal surface of the hole prevents removal of the wall plug from the hole and enables the screw to be fixed securely in the hole.

It is important that insertion of a screw into a wall plug causes expansion of the wall plug in all directions around its circumference to ensure that it engages the internal surface of the hole about its entire circumference. The bore provided in a hitherto known wall plug has therefore been formed so as to extend co-axially along the longitudinal axis of the wall plug.

A common problem that occurs when holes are drilled in a wall is that movement of the drill during drilling results in an error in the positioning of the hole. This is particularly problematic when two or more holes in a wall are required to align with fixed position holes provided in an article to be secured to the wall, and often necessitates the drilling of new holes at a position spaced from the erroneous holes.

WO 00/43682 discloses a wall plug comprising first and second portions, the first portion having a centrally located bore and the second portion having an axially offset bore. The second portion is at least partly receivable in the first portion and is adjustably rotatable relative to the first portion to adjust the rotary position of the bore in the second portion relative to the bore of the first portion. Accordingly, if the hole drilled into the wall is off-set from its intended position, rotation of the second portion relative to the first portion enables a screw to be correctly positioned without having to re-drill the hole.

Formation of the wall plug in two parts complicates insertion of the wall plug into a hole and requires the provision of a positive interface between the two parts. This is usually provided by means of splines or other mechanical means and prevents the two parts from rotating relative to each other whilst a screw is inserted into the plug, for example. Any relative rotation during insertion of a screw renders the screwing action, and therefore the plug, useless.

The provision of splines or other mechanical means causes the plug to be larger than a corresponding one-part wall plug. This in turn means that a user must drill a larger hole using a larger, less common, drill bit.

In addition, formation of the wall plug-in two parts effects the ability of the wall plug to expand at the point where the two parts meet. This means that on insertion of a screw into the wall plug, it is not possible to get the wall plug to expand along its entire length. This in turn effects engagement between the exterior of the wall plug and the inner surfaces of the hole in which the wall plug is inserted.

According to an aspect of the invention there is provided a wall plug for insertion into a hole or bore in a wall comprising an elongate body having an internal bore, the bore having an opening at a first end of the body, and rotation means located at the first end of the body, the rotation means being operable to permit the elongate body to be rotated when located in said wall hole or bore, the opening being offset from, and the bore being inclined relative to, the longitudinal axis of the body.

The provision of an inclined bore permits a screw to be inserted into the wall plug at an angle. It thereby enables a screw to be inserted through a fixed position hole in an article and fixedly secured within a hole in a wall even though the fixed position hole in the article and the hole in the wall are mis-aligned.

The provision of an inclined bore rather than an axially offset bore in the body facilitates radial expansion of the wall plug in all directions about the circumference of the wall plug. This helps to ensure that the plug engages the sides of a hole about its entire circumference.

The provision of an inclined bore also means that the overall diametrical size of the wall plug may be smaller than a wall plug having an axially offset bore.

This is because the thickness of the body of the wall plug surrounding the bore equalises progressively along the length of the wall plug. Any weakness due to the thickness of the body of the wall plug is therefore only located towards the head of the wall plug.

This is in contrast to a wall plug having an axially offset bore since in such wall plugs the body of the wall plug surrounding the bore is thinner on one side than on the other along the entire length of the wall plug. This means that any weakness due to the thickness of the body of the wall plug is located along the entire length of the wall plug. Such wall plugs are generally therefore made to have a relatively larger diametrical size to increase the depth of the “dinner portion” of the body of the wall plug and make the wall plug stronger.

The provision of an inclined bore also enables the wall plug to provide correction for a greater degree of error in the positioning of a hole than a wall plug having an axially offset bore.

This is because the inclination of the bore means that a screw entering the bore is inclined relative to the surface of the wall in which the wall plug is inserted. Such inclination means that the degree of eccentricity increases along the length of the screw, and thus the greater the depth of the fixture being fixed to the wall, the greater the eccentricity of fixing hole can be compensated for by using a wall plug according to the invention.

The rotating means facilitates positioning of the wall plug within a hole such that the opening of the inclined bore is aligned with a fixed position hole in an article to be secured to the wall.

Other advantageous features of the invention are set out in claims 2-9.

A wall plug according to an embodiment of the invention will now be described, by way of a non-limiting example, with reference to the accompanying drawings in which:

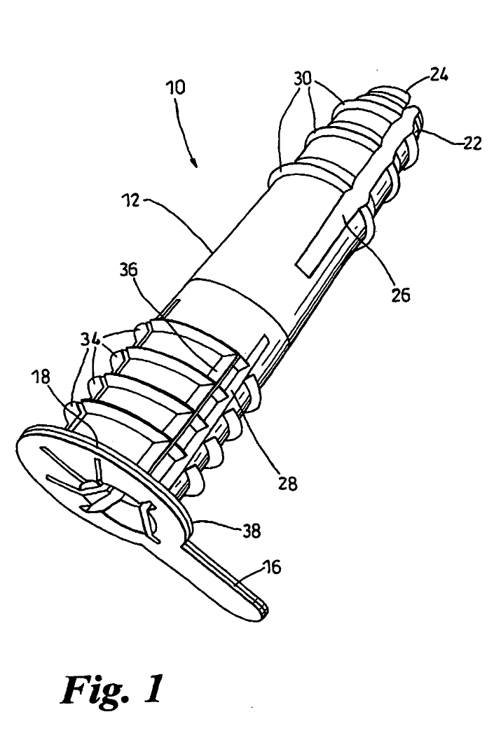

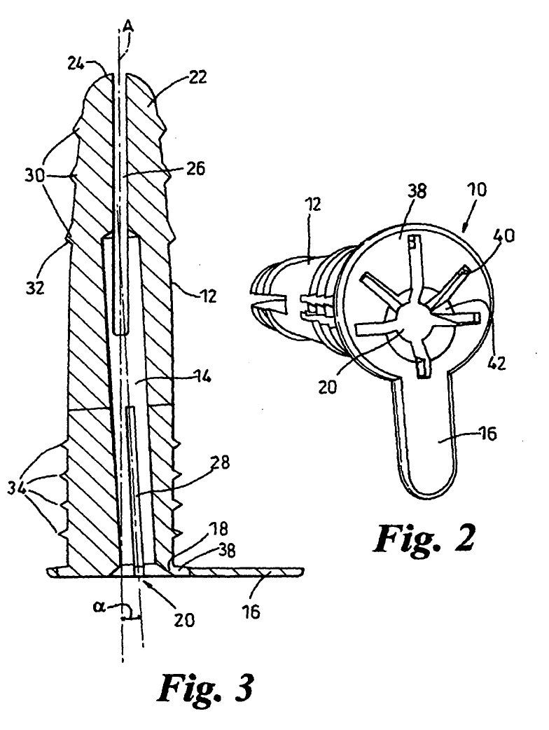

FIGS. 1 and 2 show a wall plug according to an embodiment of the invention; and

FIG. 3 shows a cross-sectional view of the wall plug of FIGS. 1 and 2.

A wall plug 10 according to an embodiment of the invention is shown in FIGS. 1 and 2.

The wall plug 10 includes an elongate body 12 having an internal bore 14 (FIG. 3).

The internal bore 14 is inclined relative to the longitudinal axis A of the body 12 and terminates in an opening 20 provided at a first end 18 of the body 12.

The internal bore 14 is inclined at an angle α to the longitudinal axis A.

Rotation means, preferably in the form of a radially extending tab 16, is provided at the first end 18 of the body 12.

The body portion 12 is preferably frustoconical, tapering in diameter from the first end 18 and terminating at a second end 22 in an arcuate surface 24. The body 12 includes at least one primary elongate slot 26 through its side wall, and preferably two pairs of opposed such primary elongate slots 26, extending from the arcuate surface 24 over part of the length of the body 12 so as to form an expansible sleeve.

Preferably the angle of inclination α of the bore 14 is chosen such that the thickness of the body 12 surrounding the opening 20 is within a preferred range, and such that the internal bore 14 extends along the longitudinal axis of the body 12 over at least part of the length of the or each primary elongate slot 26. This in turn means that the larger the wall plug 10, the greater the angle of inclination α, and eccentricity of the bore 14, may be.

The body 12 also includes at least one secondary elongate slot 28, and preferably two pairs of opposed such secondary elongate slots 28, extending from the first end 18 of the body 12 over part of the length of the internal bore 14.

A plurality of barbs 30 is provided towards the second end 22 of the body 12. The barbs 30 extend circumferentially around the body 12 at equidistantly spaced positions along the length of the or each primary elongate slot 26. Each barb defines a shoulder 32 facing the first end 18 of the body 12.

A plurality of triangular ribs 34 is also provided towards the first end 18 of the body 12. The ribs 34 extend circumferentially around the body 12 at equidistantly spaced positions along the length of the or each secondary elongate slot 28. At least one, and preferably two, longitudinally extending re-inforcing members 36 intersect the ribs 34 and resist deflection of the ribs 34 in use.

At its first end 18, the body 12 preferably includes a continuous flange or ledge 38 projecting radially from its outer surface which acts as a stop to prevent axial insertion of the body 12 into a hole drilled in a wall. The tab 16 is preferably formed integrally with the flange 38 and extends past the outer edge of the flange 38. The tab 16 provides means, in use, for rotating the wall plug 10 during insertion into a hole. As shown, the tab 16 has a thickness similar to flange 38 and is relatively thin. This enables the tab 16 to lie flat against the surface of the wall and also enables the tab 16 to be bent away from the wall to be gripped by a user for causing rotation of the body 12.

The opening 20 of the internal bore 14 is preferably frustoconical and depressed in the first end 18 of the elongate body 12, as shown in FIG. 2. The internal bore 14 extends from the base of the depressed opening 20.

Channels 40 and 41 (FIG. 2) preferably extend radially through the wall of the depressed opening 20 and the first end 18 of the body 12. Channels 40 preferably communicate with the secondary elongate slots 28. The channels 40,41 form wings 42 therebetween which are resiliently deformable.

In use, the wall plug 10 is partly inserted into a hole or cavity formed in a wall, and is rotated using tab 16 within the hole so as to align the offset opening 20 with a fixed position hole in an article to be fixed to the wall.

When the offset opening 20 is correctly positioned, the remainder of the wall plug 10 is inserted into the hole so that flange 38 engages the surface of the wall surrounding the hole.

The tab 16 may be detachable such that it may be removed once the wall plug is positioned as required within a hole in the wall, thereby preventing further rotational adjustment of the wall plug within the hole.

Frictional engagement between the ribs 34 and the internal surface of the hole prevents rotational movement of the wall plug 10 within the hole once it is fully inserted into the hole, particularly during insertion of a fixing element such as a screw, for example, into the wall plug 10.

On insertion of the fixing element into the hole, the or each secondary elongate slot 28 permits expansion of the wall plug 10 in the vicinity of its first end 18, and the or each primary elongate slot 26 permits expansion of the wall plug 10 in the vicinity of the second end 22. Such expansion increases the frictional engagement between the ribs 34 and the internal surface of the hole. It also brings the barbs 30 into frictional engagement with the internal surface of the hole. Such frictional engagement prevents movement of the wall plug 10 within the hole, and ensures that the wall plug 10 is securely received within the hole.

In particular, the shoulders 32 of the barbs 30 resist outward movement of the wall plug 10 relative to the hole. The ribs 34 also resist outward movement of the wall plug 10 relative to the hole since the or each re-inforcing member 36 resists deflection of each of the ribs 34, and ensures that the ribs 34 remain in frictional contact with the internal surface of the hole.

Since the internal bore 14 is inclined relative to the longitudinal axis A of the body 12, the fixing element may be securely fixed within a hole at an angle to the longitudinal axis of the hole. This permits the fixing element to be securely fixed in instances when the fixing element is caused to enter a hole at an angle through mis-alignment of the hole within a fixed position in an article.

Since the internal bore 14 extends along the longitudinal axis of the body 12 over at least part of the length of the or each primary slot 26, the or each primary slot 26 facilitates expansion of the wall plug 10 in all directions about its circumference on insertion of a fixing element into the wall plug 10.

1. A wall plug for insertion into a bore in a wall comprising:
an elongate body having an internal bore, the bore having an opening at a first end of the body, and rotation means located at the first end of the body, the rotation means being operable to permit the elongate body to be rotated when located in said wall bore, the opening being offset from, and the bore being inclined relative to, the longitudinal axis of the body.

2. A wall plug as claimed in claim 1 wherein,
said rotation means includes an outwardly extending tab provided at said first end of said body.

3. A wall plug as claimed in claim 1 wherein,
said body is frustoconical, tapering in diameter from said first end of said body towards a second end of said body.

4. A wall plug as claimed in claim 2 wherein,
said body is frustoconical, tapering in diameter from said first end of said body towards a second end of said body.

5. A wall plug as claimed in claim 3 wherein,
a radially outward extending flange is provided extending radially outwards from said first end of said body.

6. A wall plug as claimed in claim 4 wherein,
a radially outward extending flange is provided extending radially outwards from said first end of said body.

7. A wall plug as claimed in claim 1 wherein,
said body includes one or more primary elongate slots through its side wall extending axially from a second end of said body.

8. A wall plug as claimed in claim 7 wherein,
said inclined, bore extends along said longitudinal axis of said body over at least part of the length of at least one primary elongate slot

9. A wall plug as claimed in claim 1 wherein,
said body includes one or more secondary elongate slots through its side wall extending axially from said first end of said body.

10. A wall plug as claimed in claim 1 wherein,
said body includes a plurality of circumferentially extending ribs equidistantly spaced apart at said first end of said body.

11. A wall plug as claimed in claim 1 wherein,
said body includes a plurality of circumferentially extending barbs equidistantly spaced apart at a second end of said body.
